(19) United States
(12) Patent Application Publication
(10) Pub. No.: US 2009/0220004 A1
(43) Pub. Date: Sep. 3, 2009

(54) Error Concealment for Scalable Video Coding

(75) Inventors: Leszek Cieplinski, Surrey (GB); Soroush Ghanbari, Surrey (GB)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 12/087,517

(22) PCT Filed: Jan. 11, 2007
(86) PCT No.: PCT/GB2007/000081

§ 371 Date: Jan. 22, 2009

(30) Foreign Application Priority Data
Jan. 11, 2006 (EP) 06250122.6

(51) Int. Cl. H04N 11/02

(52) U.S. Cl. 375/240.16; 375/E07.026

(57) ABSTRACT

A method of deriving replacement block information, such as a replacement motion vector, for a lost or damaged image block in scalable video coding comprises combining information about neighbouring block information in at least the current layer and the corresponding and/or neighbouring blocks in at least one other layer, to derive said replacement block information.

Transmission of compressed video bitstreams is, in general, very sensitive to channel errors. For instance, a single bit error in a coded video bitstream may cause severe degradation of picture quality. When bit errors occur during transmission, which cannot be fully corrected by an error correction scheme, error detection and concealment is needed to conceal the corrupted image at the receiver.

Error concealment algorithms attempt to repair the damaged part of the received picture. An overview of the state of the art in this area can be found in “Error Resilient Video Coding Techniques” in IEEE Signal Processing Magazine, Vol. 17, Issue 4, pages 61-82, July 2001, by Yao Wang, Stephan Wenger, Jaingtao Wen, and Aggelos K. Kassaggelos. The techniques can be classified into two broad classes: Spatial & Temporal Concealment. In Spatial Concealment, missing data are reconstructed using neighbouring spatial information, whilst in Temporal Concealment the lost data are reconstructed from the data in the temporally adjacent frames.

One simple temporal concealment technique simply replaces the damaged block with the spatially corresponding block in the previous frame. This method is referred to as the copying algorithm. It can produce bad concealment in the areas where motion is present. Significant improvements can be obtained by replacing the damaged block with the motion-compensated block, but to do this a true motion vector needs to be recovered.

Several motion vector recovery techniques are widely used to conceal the damaged block as follows:
The motion-compensated block obtained with the “Average” of the motion vectors of its neighbouring blocks.
The motion-compensated block obtained with the “Median” of the motion vectors of its neighbouring blocks.
Boundary matching algorithm described in “Recovery of lost or erroneously received motion vectors” by W. Lam, A. R. Reibman, and B. Liu (IEEE Proc. of Int. Conf. Acoustics, Speech, Signal Processing, pages 545-548, March 1992). From a set of candidate motion vectors (MVs), each MV is tested for concealment and the selected MV is the one that minimizes the mean square error between its boundaries and the boundaries adjacent to them from the top, bottom and left macroblocks around the area to be concealed. The boundary used for this calculation can be easily adjusted depending on the availability of neighbouring reconstructed macroblocks.

Generally the Median method, also known as the Vector Median, is used to estimate the lost MV from a set of candidate MVs. The Vector Median gives the least distance from all the neighbouring candidate vectors. As a result, it is a good method for choosing one of the neighbouring MVs for the reconstruction of the missing block MV. The drawback of this method is the high computational cost, which makes it not viable for use in applications with limited processing power, for example in a video mobile environment.

The technique proposed in European Patent Application EP1395061, incorporated herein by reference, uses an algorithm simpler than the Vector Median for selecting one of the neighbouring block MVs. The average of the surrounding blocks motion vectors gives the minimum distortion from all the surrounding motion vectors. However, in a situation where the surrounding motion vectors have significantly different directions, cancellation between vectors of opposite direction can result in the average vector having a magnitude small by comparison with the neighbouring candidate vectors. It is more probable that the missing vector will be closer to the average vector than to vectors that are most dissimilar to the average. Following this argument, the vector closest to this average is chosen. This method will be referred to as Nearest-to-Average (N-t-A method).

In scalable video coding, in particular in the approach taken in the MPEG/ITU-T JVT SVC codec and in some wavelet-based video codecs, the motion vectors can be transmitted in a scalable fashion. The base layer of the bitstream has a coarse representation of the motion vectors, which may be refined in the enhancement layers. In particular, in the current draft of the MPEG-4 AVC Scalable Video Coding amendment (Joint Draft 4, JVT document number JVT-Q201), depending on the macroblock coding mode, three options are available:
1. the MV components are left the same as in base layer
2. the MV components are refined by −1, 0, or 1 (in quarter pel units)
3. a new MV is transmitted without reference to the base layer MV.

In many application scenarios for scalable video coding, the base layer is expected to have stronger error protection than the enhancement layer and thus it is quite likely that the motion vector refinement for a particular block will be lost while its coarse representation will be available.

In “Error concealment for SNR scalable video coding” by Ghandi & Ghanbari (Signal Processing: Image Communication, 2005, in press), error concealment in the enhancement layer is carried out by selecting one of the following choices:
1. a motion compensated block of the previous enhancement picture using an estimate of the current MV based on neighbouring MVs (forward)
2. the corresponding base layer block (upward)
3. the motion compensated block using the corresponding base MV (direct)

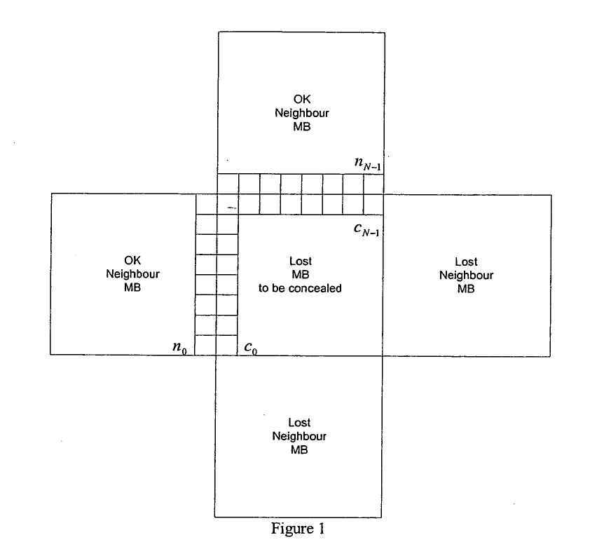

The three options are then examined and the one with the lowest boundary distortion (D) is selected to replace the missing block. The block boundary distortion is defined as:

$${D}_{e} = \frac{1}{N} {\sum }_{i = 0}^{N - 1} \vert {c}_{i} - {n}_{i} \vert$$

where cᵢ and nᵢ are boundary pixels of the correctly received neighbouring blocks and the substituted pixels, respectively (see FIG. 1).

Relatively few error concealment algorithms address motion recovery in scalable video coding scenario. The existing error concealment techniques are either straightforward extensions of non-scalable concepts or use simple copying and scaling of base layer MVs and/or texture and are therefore not optimally adapted to deal with the error patterns that may occur in the case of scalably encoded motion vectors. In particular, they do not take advantage of all the information available in all the temporal, spatial and quality layers to efficiently estimate the lost motion vectors and block coding/partitioning modes.

Aspects of the invention are set out in the accompanying claims.

In a first aspect, the invention relates to a method of deriving block information for an image block in scalable video coding, where encoded block data are provided in a plurality of layers at different levels of refinement, the method comprising combining information about neighbouring block information in at least the current layer and/or image and the corresponding and/or neighbouring blocks in at least one other layer and/or image to derive said replacement block information.

Neighbouring here means spatially or temporally neighbouring. Current image can mean the current image in any layer, and another image means a temporally different image, such as a previous or subsequent image, and can also mean the temporally different image in any layer.

In a second aspect, the invention relates to a method of deriving block information for an image block in scalable video coding, where encoded block data are provided in a plurality of layers at different levels of refinement, the method comprising combining available block information from at least two of: spatially neighbouring blocks in the current layer, temporally neighbouring blocks in the current layer, a corresponding block in a first other layer for the current frame, a corresponding block in a second other layer for the current frame, blocks spatially neighbouring a corresponding block for the current frame in a first other layer, blocks temporally neighbouring a corresponding block for the current frame in a first other layer, blocks spatially neighbouring a corresponding block for the current frame in a second other layer, and blocks temporally neighbouring a corresponding block for the current frame in a second other layer, to derive said replacement block information.

Some aspects of the invention relate to deriving block information for an image block. Usually, but not essentially, this will be replacement block information for lost or damaged block information. The block information is, for example, motion vector information, or prediction mode or block partition information. The block information for a given image block is derived using information from blocks neighbouring said image block, either temporally, spatially or in another layer (that is, using the block information for the corresponding block in another layer, or for blocks neighbouring the corresponding block in another layer). In the specification, unless otherwise apparent from the context, the term motion vector includes motion vector refinements, such as in layers above the base layer in scalable coding.

An underlying feature of embodiments of the invention is to combine all the available information from all the layers in the formation of the estimate of the current layer motion vector. It can be expected that at least some of the following candidates will be available:
MVs from spatially adjacent blocks in the current layer
MVs from temporally adjacent blocks in the current layer
Coarse (base/lower layer) MVs in the current frame (for current block and neighbouring blocks for which the current layer MV is not available)
Coarse (base/lower layer) MVs from previous and future frames
MV refinements from higher layers in the current frame
MV refinements from higher layers from previous and future frames.

The estimate of the current MV is formed using some or all of the available candidate MVs using a criterion aiming at minimisation of the concealment error.

Embodiments of the invention will be described with reference to the accompanying drawings, of which:

FIG. 1 illustrates boundary pixels of a lost block (MB);

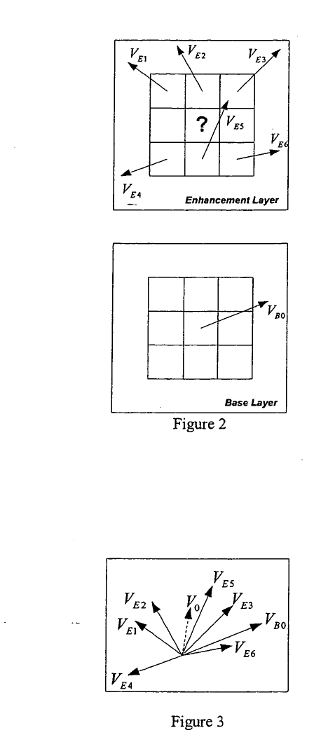

FIG. 2 illustrates motion vector candidates from base & enhancement layer frames;

FIG. 3 illustrates selecting a candidate MV that is closest to the average MV V₀;

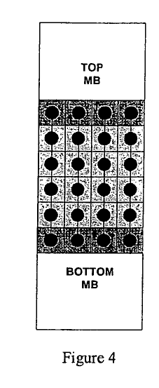

FIG. 4 illustrates interpolation of top & bottom blocks (MB) for spatial concealment;

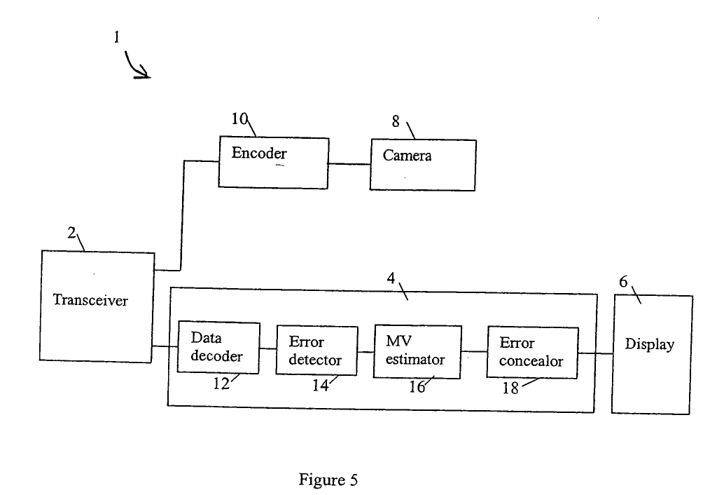

FIG. 5 is a schematic block diagram of a mobile videophone;

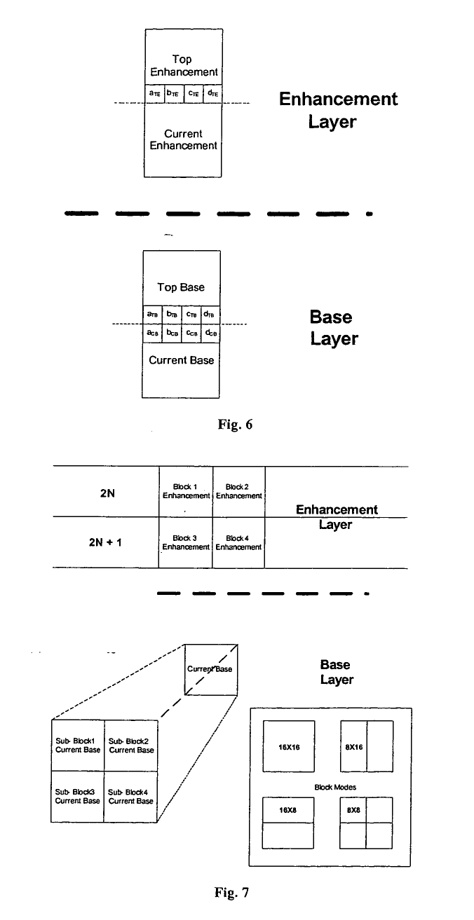

FIG. 6 illustrates neighbouring blocks in a base layer and an enhancement layer;

FIG. 7 illustrates various aspects of spatial scalability and block modes; and

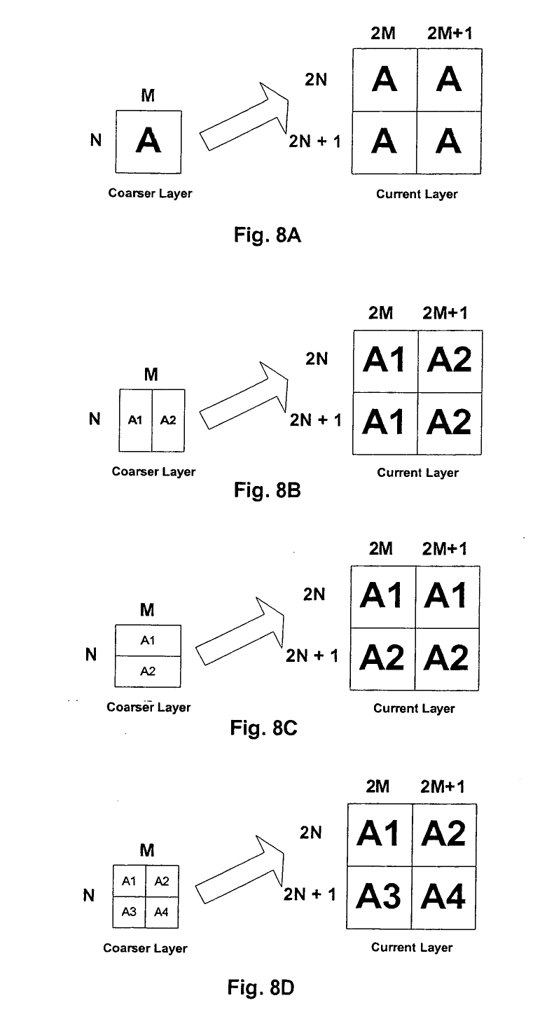

FIGS. 8A to 8D illustrate the relationship between blocks in a base layer and an enhancement layer for different block modes.

Embodiments of the invention will be described in the context of a mobile videophone in which image data captured by a video camera in a first mobile phone is transmitted to a second mobile phone and displayed.

FIG. 5 schematically illustrates the pertinent parts of a mobile videophone 1. The phone 1 includes a transceiver 2 for transmitting and receiving data, a decoder 4 for decoding received data and a display 6 for displaying received images. The phone also includes a camera 8 for capturing images of the user and a coder 10 for encoding the captured images.

The decoder 4 includes a data decoder 12 for decoding received data according to the appropriate coding technique, an error detector 14 for detector errors in the decoded data, a motion vector estimator, 16 for estimating damaged motion vectors, and an error concealer 18 for concealing errors according to the output of the motion vector estimator.

A method of decoding received image data for display on the display 6 according to embodiments of the invention will be described below.

Image data captured by the camera 8 of the first mobile phone is coded for transmission using a suitable known technique using frames, macroblocks and motion compensation, such as an MPEG-4 technique, for example. The data is scalably encoded in the form of base and enhancement layers, as known in the prior art. The coded data is then transmitted.

The image data is received by the second mobile phone and decoded by the data decoder 12. As in the prior art, errors occurring in the transmitted data are detected by the error detector 14 and corrected using an error correction scheme where possible. Where it is not possible to correct errors in motion vectors, an estimation method for deriving a replacement motion vector is applied, as described below, in the motion vector estimator 16.

The first implementation is based on adding the coarse MV as an additional candidate in the Nearest-to-Average method (N-t-A) known from prior art.

The top part of FIG. 2 shows an example of MVs in the current layer, denoted V_{E1} to V_{E6}, which would be used for MV recovery in the N-t-A method described above. In the current implementation of the inventive idea we add the base layer MV denoted V_{B0} in the bottom part of FIG. 2 to the set of candidate MVs.

In FIG. 3, V₀ is the average of the candidate MVs: V_{E1}-V_{E6} & V_{B0}. In this example, the closest MV to V₀ is V_{E5}. Hence V_{E5} is selected to replace the missing MV in the current layer.

In the example above, it is assumed that the MVs in the current layer from blocks above and below the current block have been correctly decoded. If more MVs in the current layer (e.g. the left and right neighbours) are available they can also be used for prediction. More MVs from the base layer, other pictures in the current layer, as well as the MVs incorporating refinements from the higher enhancement layers can be added to the candidate set. This is particularly useful if fewer or especially no MVs in the current layer are available.

The following describes the possible alternatives and enhancements to the basic scheme described above. The alternative candidate selection methods can be used to replace the N-t-A method outlined above. The spatial concealment algorithm can be used in combination with the basic scheme. The use of higher-level motion enhancements can be used either as an alternative candidate selection method or as a refinement of the N-t-A or the alternative algorithms.

In a second implementation, the candidate selection is based on the direction/magnitude of the MV for the current block in the base layer. The MV candidates of spatially/temporally adjacent blocks are selected that have similar direction/magnitude as the MV of the current block in the base layer. The candidate MV can also be further modified by combining this selected MV in the current layer with the MV in the base layer (e.g. taking the average of the two MVs).

In a third implementation, information about the MV refinements in the current layer is used to guide the candidate selection process. For example, if all the MV refinements in the current layer are small (e.g. 0), the decision is taken to use the base layer motion vector as it is very likely that the refinement for the current block is also very small.

A fourth selection method is to look at surrounding blocks. If the majority of these neighbouring blocks take their prediction from the base layer, then the MV for the current block is copied from the base layer. If the majority of neighbouring blocks take their prediction from previous frame, then the lost MV is estimated with reference to the previous frame. Also if the majority of blocks take their prediction from the next frame, then the lost MV is estimated with reference to the next frame. With this selection method, once the reference picture is selected, then the lost MV is estimated as before. Using this estimated MV, the lost block is concealed using one of the selected reference pictures (base, previous current, future current, etc. . . .)

In a fifth implementation, the information from different layers (particularly base/coarser layers) is used as an additional error criterion. An example of this is a two-step selection algorithm consisting of using the block boundary matching in the first step and comparison of motion compensation to upsampled base layer block in the second step. In a variation of this scheme, a combined error measure is introduced based on the weighted average of the error boundary measure and difference between upsampled base layer block and motion compensated block.

It is also possible to use the refinements of motion vectors that come from higher quality levels (higher layer motion vector refinements) as in a sixth implementation.

The simplest use of the refinement information is to restrict the possible range of the motion vector based on the enhancement motion vector not being allowed to point outside the range specified by the syntax or the known encoder configuration. This means that the candidate MVs that would result in invalid MVs in the next enhancement layer can be removed from consideration.

A more sophisticated approach, which can be used in combination with the simple restriction, analyses the characteristics of the available MV refinements. This analysis may either be based on simple determination of the dominant direction of the MV enhancements or more sophisticated statistical analysis. The information obtained is then used either solely or in combination with other criteria to guide the selection process among the candidate MVs. For example, if the MV refinement is available for the current block location, the candidate motion vector that has the closest corresponding refinement is selected as the estimate for the current block MV. In a more sophisticated implementation, the closeness of the refinement is combined with other information (e.g. the pre-selection of candidate MVs belonging to dominant cluster, the block edge difference, etc.).

As a special case, it is also possible to use the analysis of the refinement motion vector field to recover lost motion vectors in the base layer. In one implementation, the correlation between the MV refinements in the enhancement layer corresponding to the received MVs in the base layer and those corresponding to the lost MVs is used to guide the selection of the base layer MVs to be used for concealment.

A seventh implementation relates to spatial concealment. If neighbouring blocks in the current layer are intra coded then the lost block can use intra prediction/interpolation from neighbouring reconstructed blocks for concealment, subject to an error criterion. Often, when errors occur, multiple blocks in the same horizontal line are corrupted. Because of this it is advantageous to estimate a damaged block from information contained in the blocks from the rows above and below the block in which the error occurs. An example of such interpolation is shown in FIG. 4, where interpolation between the block on the top and the block on the bottom of the current block is employed.

The decision on the use of spatial prediction/interpolation is then based on a suitable error measure. An example of this is the mean square error between the estimated current block and its upsampled base layer version.

Similar ideas to those above can be applied to the recovery of the macroblock mode, macroblock and sub-macroblock partition information.

When a block is lost its information such as block mode will be lost too. If the surrounding block modes use bi-directional prediction then the lost block will be treated as bidirectional mode and its lost MV will be concealed using bidirectional motion compensation from previous and future enhancement pictures.

In the case where on one side (e.g. right hand side) of the macroblock the majority of macroblocks are INTRA coded, then the lost macroblock will be partitioned into two sections. In one section concealment is carried out using spatial concealment from the neighbouring intra macroblocks and the other partition of the lost macroblock will be concealed by estimating a lost MV from surrounding neighbouring INTER macroblocks.

In MPEG-4 AVC/H.264 a macroblock can be partitioned in a number of ways for the purpose of motion estimation and compensation. The partitioning modes are 16×16, 16×8, 8×16 and 8×8. Each macroblock can have more than one MV assigned to it depending on its partitioning mode. For the 16×16 block size one MV is needed, for the 16×8 and 8×16 two MVs are required and for the 8×8 mode 4 MVs are required. To estimate the lost MB mode the surrounding macroblocks' modes are examined. For example if the majority of MVs have 16×8 mode then the lost macroblock mode is assigned 16×8 mode. Hence two MVs will need to be estimated from surrounding neighbours to conceal the lost MV. Similarly, when the 8×8 partitioning is used, the 8×8 blocks may be further subdivided into 8×4, 4×8 and 4×4 sub-blocks. These sub-macroblock partitioning modes can be recovered in similar fashion to the macroblock partitioning modes described above.

Further methods for selecting candidate motion vectors are set out below. The candidate motion vectors can then be processed, for example, to derive replacement block information, such as a replacement or estimated motion vector, using suitable methods such as described above or in the prior art.

An eighth implementation relates to thresholds and weights.

Information directly below the current layer can be especially important. For example, for two layers, with the lower layer called the base layer and the higher layer called the enhancement layer, then it is more probable that the information in enhancement layer blocks will be similar to the information of the corresponding block in the base layer.

The problem to be solved is how to predict the motion vector (MV) of a block as a function of surrounding block MVs in the enhancement layer and base layer. The current implementation involves determining weights that control the effect of the candidate MVs on the estimated MV. The values of the weights are determined based on the similarities between the base layer and enhancement layer MVs.

Weights assigned to the candidate MVs are selected depending on the similarities between available MVs. In particular, in the current implementation, two aspects of the relationships between the available MVs are considered. For a given block, described as the current block, having a missing or damaged motion vector to be estimated, the following are considered:
1. similarities of MVs for the current block in the base layer and spatially neighbouring MVs in the base layer;
2. similarities between the MVs of the same spatially neighbouring block in the base and enhancement layers.

In a specific implementation, the similarity measure values are categorised into three ranges (high, medium, low) defined by two thresholds. If the similarity measure is high the corresponding block information is assigned high weight and the other block information is assigned low weight. If the similarity measure is in the medium range, then the information from the two categories of blocks are assigned medium weights. Finally, if the similarity measure is low, then the weight for the corresponding block information is further reduced while the weight for the other block information is further increased.

The two aspects are explained below with reference to FIG. 6. FIG. 6 illustrates a current block in the base and enhancement layers, and a spatially neighbouring block in the base and enhancement layers. In particular, the spatially neighbouring block is the block vertically above the current block, described as the top block. In the following, the current and top blocks in the base and enhancement layers are described as Current Base, Current Enhancement, Top Base and Top Enhancement.

In a specific implementation of aspect 1, the motion vectors (MVs) of the two blocks, Top Base and Current Base in the base layer are compared. As, in MPEG-4 SVC, each block can have up to 16 sub-blocks, so that each block's boundary can have up to 4 sub-blocks, such as blocks: a, b, c and d in the block Current Base, as shown in FIG. 6. The sum of the Euclidean distance between the MV of each subblock in the Top Base and the MV of the corresponding sub-block in the Current Base block is then calculated, resulting in a distance measure DistS between the two neighbouring blocks, defined in equation (1) as follows.

$$Dist = {\sum }_{i ∈ \{ a , … , d \}} {( {V}_{{i}_{TB} , x} - {V}_{{i}_{CB} , x} )}^{2} + {( {V}_{{i}_{TB} , y} - {V}_{{i}_{CB} , y} )}^{2} , \qquad ( 1 )$$

where Vᵢ_{_{TB}} & Vᵢ_{_{CB}} are the MVs for the Top Base & Current Base blocks respectively, and each MV is composed of x & y components.

If the measure DistS is below a first threshold, TH1, indicating that the MVs in Top Base block are very similar to MVs in the Current Base block, then the MVs in the enhancement layer may have a high correlation to the lost MV. Hence the weighting factor of the MVs in base layer is kept at a minimum. However, if the measure DistS is above the first threshold, THS1, but below a second threshold, THS2, where THS2>THS1, then the weighting factor of the base layer is increased. Finally, if the measure DistS is above THS2, then the MVs of the enhancement layers are assigned lower weight or even discarded and only base layer MVs are used to recover the lost MV.

In the second aspect, the MVs of two layers are compared. As illustrated in equation 2, the Euclidean distance DistL is calculated using the MVs from the sub-blocks in the Top Enhancement block & the MVs in the Top Base block.

$$Dist = {\sum }_{i ∈ \{ a , … , d \}} {( {V}_{{i}_{TE} , x} - {V}_{{i}_{TB} , x} )}^{2} + {( {V}_{{i}_{TE} , y} - {V}_{{i}_{TB} , y} )}^{2} , \qquad ( 2 )$$

where, Vᵢ_{_{TE}} & Vᵢ_{_{TB}} are the MVs for the Top Enhancement & Top Base blocks respectively.

The measure DistL, as before is compared to two thresholds. However, this time, if the measure DistL, is below the first threshold, THL1, then only the base layer MVs are used for calculation of the lost MV (more generally the base layer MVs are used with highest weight). If DistL is above THL1, but below THL2, where THL2>THL1, then weight assigned to the base layer MVs is decreased and the weight assigned to the enhancement layer MVs is increased. If DistL is greater than THL2, the weight for the enhancement layer is further increased and that of the base layer is further decreased.

Other distance measurements can be used as a similarity measure.

In both the first and second aspects, the weightings are used in deriving the estimated MV, for example, in averaging the candidate MVs or other similar method. Alternatively, as mentioned above, the weightings may be used to decide whether to include or exclude MVs from the candidate set of MVs, which is then processed to derive the estimated MV, for example, using a method as described above or in the prior art.

In the first approach (see equation 1), the similarity measure involves spatial information in the base layer. However, in the second approach (see equation 2), the similarity measure involves different layers.

In other words, in general terms, in the first approach, for a current block (in the enhancement layer) having a missing or damaged MV, if MVs for one or more blocks neighbouring the current block in the base layer are similar to the MVs for the current block in the base layer, it is reasonable to assume the same applies for the current enhancement layer, and therefore more weight is assigned to MVs in the enhancement layer.

In the second approach, in general terms, if the neighbouring MVs in the enhancement layer are not similar to the corresponding neighbouring MVs in the base layer, then the MVs in the enhancement layer are given higher priority or higher weighting, whereas if the neighbouring MVs in the enhancement layer are similar to the corresponding MVs in the base layer, then the MVs in the base layer are given higher priority or higher weighting.

An eighth implementation relates to spatial scalability.

In scalability, a one-to-one mapping between two layers is not always possible. For example, in spatial scalability, a block in the base layer corresponds to four blocks in the enhancement layer, giving a one-to-many correspondence. Hence, for example, in the enhancement layer each two rows correspond to one row in the base layer as illustrated in FIG. 7. In particular, for example, blocks 1 to 4 in the enhancement layer as shown in the top section of FIG. 7 correspond to a single block in the base layer (not shown), and the four blocks lie in two rows, row 2N (blocks 3 and 4) and row 2N+1 (blocks 1 and 2).

In MPEG-4 SVC, each top-level block of size 16×16 pixels (referred to as macroblock) can have sub-blocks of various sizes. In general, there can be 1, 2, and 4 sub-blocks of sizes 16×16, 16×8, 8×16 or 8×8. The 8×8 sub-blocks can be further partitioned into 4×4 sub-sub-blocks, each of them having a different MV. This is illustrated in the bottom section of FIG. 7.

The one-to-many correspondence between blocks and subblocks in spatial scalability can be used to better guide the MV candidate selection process based on a number of observations about the relationships between the blocks in different layers.

If a base layer block is size 16×16, then it is most likely that its 4 corresponding blocks in the enhancement layer will be of mode 16×16. In this case, for estimating the block information in the odd (2N+1) rows of the enhancement layer, the block information in the even rows (2N) enhancement layer will be similar to odd row blocks. This can be understood with reference to FIG. 8A, where the block (A) in the coarser layer shown is 16×16 block.

In this case, the enhancement layer blocks in those rows are given higher precedence. A similar argument applies to the 8×16 blocks and they are therefore treated in the same manner (see FIG. 8B; each of the blocks A1 and A2 are 8×16).

However, if the base layer block size if 16×8, then it is more likely that the blocks in the even columns (2M) will be similar to blocks in the odd columns (2M+1) in the enhancement layer (see FIG. 8C; each of the blocks A1 and A2 are 16×8). As a result, for this situation, when estimating the block information in the even columns (2M), the corresponding blocks in the odd columns (2M+1) are given higher precedence.

Lastly, if the base layer block is 8×8, no strong correlations are expected to exist between the neighbouring macroblocks in the enhancement layer (see FIG. 8D; each of the blocks A1, A2, A3 and A4 are 8×8).

Examples of applications of the invention include videophones, videoconferencing, digital television, digital high-definition television, mobile multimedia, broadcasting, visual databases, interactive games. Other applications involving image motion where the invention could be used include mobile robotics, satellite imagery, biomedical techniques such as radiography, and surveillance.

In this specification, the term “frame” is used to describe an image unit, including after processing, such as filtering, changing resolution, upsampling, downsampling, but the term also applies to other similar terminology such as image, field, picture, or sub-units or regions of an image, frame etc. The terms pixels and blocks or groups of pixels may be used interchangeably where appropriate. In the specification, the term image means a whole image or a region of an image, except where apparent from the context. Similarly, a region of an image can mean the whole image. An image includes a frame or a field, and relates to a still image or an image in a sequence of images such as a film or video, or in a related group of images.

The image may be a grayscale or colour image, or another type of multi-spectral image, for example, IR, UV or other electromagnetic image, or an acoustic image etc.

The invention is preferably implemented by processing electrical signals using a suitable apparatus.

The invention can be implemented for example in a computer-based system, with suitable software and/or hardware modifications. For example, the invention can be implemented using a computer or similar having control or processing means such as a processor or control device, data storage means, including image storage means, such as memory, magnetic storage, CD, DVD etc, data output means such as a display or monitor or printer, and data input means such as a receiver, or any combination of such components together with additional components. Aspects of the invention can be provided in software and/or hardware form, or in an application-specific apparatus or application-specific modules can be provided, such as chips. Components of a system in an apparatus according to an embodiment of the invention may be provided remotely from other components.

1. A method of deriving block information for an image block in scalable video coding, where encoded block data are provided in a plurality of layers at different levels of refinement, the method comprising combining information about neighbouring block information in at least the current layer and/or image and the corresponding and/or neighbouring blocks in at least one other layer and/or image, to derive said replacement block information.

2. A method of deriving block information for an image block in scalable video coding, where encoded block data are provided in a plurality of layers at different levels of refinement, the method comprising combining available block information from at least two of: spatially neighbouring blocks in the current layer, temporally neighbouring blocks in the current layer, a corresponding block in a first other layer for the current frame, a corresponding block in a second other layer for the current frame, blocks spatially neighbouring a corresponding block for the current frame in a first other layer, blocks temporally neighbouring a corresponding block for the current frame in a first other layer, blocks spatially neighbouring a corresponding block for the current frame in a second other layer, and blocks temporally neighbouring a corresponding block for the current frame in a second other layer, to derive said replacement block information.

3. The method of claim 1 for deriving a motion vector for a block.

4. The method of claim 3 comprising analysing characteristics of motion vectors of blocks neighbouring said image block in the current layer and/or at least one other layer.

5. The method of claim 4 comprising selecting motion vectors of neighbouring blocks based on similarity to the motion vector of said image block in at least one other layer.

6. The method of claim 4 comprising selecting motion vector characteristics on the basis of a majority.

7. The method of claim 6 comprising selecting the majority value motion vector characteristic.

8. The method of claim 3 wherein said characteristics comprise direction and/or magnitude.

9. The method of claim 3 comprising combining one or more selected motion vectors from different layers.

10. The method of claim 9 comprising combining motion vectors from neighbouring blocks in the current layer and the corresponding and/or neighbouring blocks in at least one other layer.

11. The method of claim 9 comprising calculating an average of motion vectors from neighbouring blocks in the current layer and the corresponding and/or neighbouring blocks in at least one other layer.

12. The method of claim 11 comprising selecting the motion vector used in the averaging that is closest to the average value as the replacement motion vector.

13. The method of claim 12 wherein the average is the mean.

14. The method of claim 3 comprising weighting selected motion vectors for said combining.

15. The method of claim 3 comprising comparing a plurality of motion vectors for blocks neighbouring said image block in the same layer and/or at least one other layer, and selecting and/or weighting motion vectors for said combining based on said comparing.

16. A method of deriving a motion vector for an image block in scalable video coding, where encoded block data are provided in a plurality of layers at different layers of refinement, using selected and/or weighted motion vectors of blocks neighbouring said image block in the same layer and/or at least one other layer, the method comprising selecting and/or weighting motion vectors based on block size and/or comparing a plurality of motion vectors for blocks neighbouring said image block in the same layer and/or at least one other layer, and selecting and/or weighting motion vectors based on said comparing.

17. The method of claim 16 comprising combining the selected and/or weighted motion vectors to derive said motion vector.

18. The method of claim 3 comprising evaluating similarity between a plurality of motion vectors for blocks neighbouring said image block in the same layer and/or at least one other layer, and determining whether to select motion vectors for said combining from the current layer and/or at least one other layer based on said similarity.

19. The method of claim 3 comprising evaluating similarity between a plurality of motion vectors for blocks neighbouring said image block in the same layer and/or at least one other layer, and weighting motion vectors selected for said combining based on said similarity.

20. The method of claim 18 wherein the step of evaluating similarity comprising calculating a similarity value, and comparing said similarity value with at least one threshold.

21. The method of claim 3 comprising comparing motion vectors in the current layer and a coarser layer, and combining motion vectors from the current layer and/or the coarser layer, wherein, in the combining, the influence of motion vectors in the coarser layer is directly related to the similarity between motion vectors in the current layer and the coarser layer.

22. The method of claim 3 comprising comparing motion vectors in a coarser layer, and combining motion vectors from the current layer and/or the coarser layer, wherein, in the combining, the influence of motion vectors in the coarser layer is inversely related to the similarity between motion vectors in the coarser layer.

23. The method of claim 3 comprising selecting and/or weighting motion vectors for said combining based on block size.

24. The method of claim 3 wherein a plurality of blocks in the current layer correspond to the same block in the coarser layer, the method comprising assigning greater influence, for example, in selecting, weighting or combining, to a block neighbouring said image block which corresponds to the same block in the coarser layer as said image block.

25. The method of claim 4 wherein said characteristics comprise type of prediction, such as prediction with respect to another layer, the previous frame or the next frame.

26. The method of claim 3 applied to other block information such as prediction mode or block partition, instead of motion vector information.

27. A method of deriving a replacement motion vector for a lost or damaged motion vector for an image block in scalable video coding, where encoded block data are provided in a plurality of layers at different levels of refinement, the method comprising selecting motion vectors of neighbouring blocks in the layer of said image block having similar direction and/or magnitude of the motion vector of the corresponding block in a lower layer.

28. A method of deriving a replacement motion vector for a lost or damaged motion vector for an image block in scalable video coding, where encoded block data are provided in a plurality of layers at different levels of refinement, the method comprising deciding whether or not to use the motion vector of the corresponding block in a lower layer based on an evaluation of neighbouring motion vectors in the layer of said image block, such as whether or not they are close to zero.

29. A method of deriving a replacement motion vector for a lost or damaged motion vector for an image block in scalable video coding, where encoded block data are provided in a plurality of layers at different levels of refinement, the method comprising referring to motion vectors of a higher layer.

30. A method of deriving a replacement block information, such as mode or partition information, for lost or damaged block information for an image block in scalable video coding, where encoded block data are provided in a plurality of layers at different levels of refinement, based on said block information for neighbouring blocks in the layer of said image and for neighbouring blocks and/or the corresponding block in at least one other layer.

31. The method of claim 1 using a higher layer to the current layer.

32. The method of claim 1 using the base layer.

33. The method of claim 1 further comprising evaluating the block information, such as motion vector information, using information from at least two layers.

34. A method of concealing an error in an image block comprising using block information derived using the method of claim 1.

35. A method of concealing an error in an image block comprising determining whether or not neighbouring blocks are intra coded, and using this information to guide the use of spatial prediction/interpolation from one or more neighbouring blocks.

36. The method of claim 35, where for the neighbouring intra coded blocks used for spatial prediction/interpolation of the current block, for which the current layer enhancements are not available, the upsampling of their base layer representation is used.

37. The method of claim 35 further comprising evaluating based on a comparison of the interpolated block and an upsampled version of the corresponding block.

38. A method of evaluating replacement block information for lost or damaged block information for an image block in scalable video coding, where encoded block data are provided in a plurality of layers at different levels of refinement, the method comprising using information from at least two layers.

39. The method of claim 38 comprising combining information from at least two layers.

40. The method of claim 39 comprising a combination of an error measure based on block boundary distortion and an error measure based on comparison of the block with replaced block information with an upsampled version of the corresponding block of a lower layer.

41. A computer program for executing a method as claimed in claim 1.

42. A data storage medium storing a computer program as claimed in claim 41.

43. A control device or apparatus adapted to execute a method as claimed in claim 1.

44. Apparatus as claimed in claim 43 comprising a data decoding means, error detecting means, a motion vector estimator and error concealing means.

45. A receiver for a communication system or a system for retrieving stored data comprising an apparatus as claimed in claim 43.

46. A receiver as claimed in claim 45 which is a mobile videophone.
